(19) United States
(12) Patent Application Publication
(10) Pub. No.: US 2009/0087700 A1
(43) Pub. Date: Apr. 2, 2009

(54) Operation of a Fuel Cell

(75) Inventors: Otto F Carlisle, Sussex (GB); Gerard P.T. Sauer, London (GB)

Correspondence Address: Tod T. Tumey, P.O. BOX 22188, HOUSTON, TX, 77227-2188, US

(73) Assignee: AFC ENERGY PLC, London (GB)

(21) Appl. No.: 12/281,797

(22) PCT Filed: Mar. 7, 2007
(86) PCT No.: PCT/GB07/50105

§ 371 Date: Oct. 20, 2008

(30) Foreign Application Priority Data
Mar. 7, 2006 (GB) 0604597.5

(51) Int. Cl. H01M 8/04; H01M 2/02; H01M 8/08; H01M 8/00

(52) U.S. Cl. 429/13; 429/34; 429/23; 429/25

(57) ABSTRACT

A fuel cell assembly comprises a fuel cell stack (160) with at least one fuel cell (10), and a pump (50). Each fuel cell (10) includes a first gas chamber, an electrolyte chamber, and a second gas chamber, and two electrodes separating the electrolyte chamber from the gas chambers. The pump (50) is arranged to reduce the pressure of an electrolyte (40) in the electrolyte chamber to a negative pressure. This negative pressure may be adjusted in accordance with the electrical output of the fuel cell stack (160).

The present invention relates to fuel cells, preferably but not exclusively alkaline fuel cells, and to their operation.

Fuel cells have been identified as a relatively clean and efficient source of electrical power. Alkaline fuel cells are of particular interest because they operate at relatively low temperatures and pressures, are efficient and rugged. Acid fuel cells and fuel cells employing other aqueous electrolytes are also of interest. Such fuel cells typically comprise an electrolyte chamber separated from a fuel-gas chamber (containing a fuel gas, typically hydrogen) and a further fuel-gas chamber (containing an oxidant gas, usually air). The electrolyte chamber is separated from the gas chambers using electrodes which comprise a catalyst material.

Typical electrodes for alkaline fuel cells comprise a conductive metal grid or mesh backbone, typically nickel, that provides a mechanical strength to the electrode. Onto the metal mesh or grid is deposited a slurry or dispersion of particulate poly tetra-fluoroethylene (PTFE), activated carbon and a catalyst metal, typically platinum. A further type of electrode has been previously proposed by Shell (UK patents GB 874,283 and GB 951,807) who deposited a conductive metal layer and a catalyst onto a relatively non-conductive, porous, rigid substrate made of PorvicR®, a hydrophobic sintered microporous polyvinylchloride (PVC) material.

In operation a chemical reaction occurs between the electrolyte and the fuel-gas of a fuel cell, the reaction being catalysed by the catalyst. In order for a fuel cell to operate, it is necessary for the interface between the electrolyte and a fuel-gas to be maintained at the catalyst of the electrode.

One way of controlling the position of the interface between the gas and the electrolyte is to provide a pressure differential across the electrode. The maintenance of a pressure differential may be particularly important when the electrode separating a fuel chamber and an electrolyte chamber is permeable to both the gas and the electrolyte to ensure the interface remains at the electrode and electrolyte does not leak through the electrode into the gas chamber. In order to achieve a pressure differential, it was previously proposed that the gas should be maintained at a high pressure with the electrolyte being at ambient pressure or a slightly positive pressure.

The present invention provides a fuel cell assembly comprising at least one fuel cell and a pump, the or each fuel cell including a first gas chamber, an electrolyte chamber, and a second gas chamber, and two electrodes separating the electrolyte chamber from the gas chambers, the pump being arranged to reduce the pressure of an electrolyte in the electrolyte chamber to a negative pressure.

In particular the invention provides a fuel cell assembly in which the boundary between an electrolyte chamber and a gas chamber is at least partially defined by a porous permeable electrode comprising a catalyst, the fuel cell being arranged so that in operation a liquid electrolyte fills the electrolyte chamber and a gas fills the gas chamber, the interface between the electrolyte and the gas at least partly occurring at an electrode. In operation a pressure differential is established between the liquid electrolyte in the electrolyte chamber, which is maintained at a negative pressure, and the gas in the gas chamber.

The terms “positive pressure” and “negative pressure” used herein refer to pressures with respect to atmospheric pressure, also known as relative or gauge pressures. The term “pump” used herein refers to a mechanism for lowering the pressure of a fluid and encompasses suction devices, devices for expanding the volume of a chamber and the like.

The maintenance of the electrolyte chamber at a negative pressure assists in providing a pressure differential between the electrolyte and a gas. The fuel cell may be arranged so that in operation the liquid electrolyte is at a negative pressure in the range of from −5.0 to −15.0 kPa (50 to 150 mbar). Preferably the fuel cell is arranged so that in operation the liquid electrolyte is at a negative pressure of at least −5.0 kPa, more preferably at least −8.0 kPa and still more preferably approximately −10.0 kPa. The use of a negative electrolyte pressure enables the interface between the electrolyte and gases to be positioned at the electrode without the necessity for the gas to be at a highly positive pressure. It will be appreciated that the optimum pressure differential for a particular fuel cell assembly is dependent on the properties of the electrode and the nature of the electrolyte. Accordingly, the optimum negative pressure of the electrolyte may vary.

The fuel cell assembly of the invention is advantageously arranged so that, in operation, the gas in the gas chamber may be maintained at a positive pressure for example a positive pressure of at least +1.0 kPa such as a positive pressure of approximately +2.0 kPa.

Preferably, the fuel cell assembly includes a gas pressure regulator for maintaining the gas in the gas chamber at a positive pressure during operation of the fuel cell assembly. The provision of gas at a positive pressure assists the flow of gases to the gas chambers of the fuel cell to replace gas consumed in the chemical reactions of the cell. A positive pressure of approximately +2.0 kPa has been found to be sufficient to supply gas flow to the gas chambers for both a fuel-gas and an oxidant-gas, for example the oxidant gas may be supplied at 2.5 kPa, so the pressure in the gas chamber is 2.0 kPa and the pressure at the outlet from the assembly is 1.5 kPa. Alternatively the fuel cell may be so arranged that the gas in the gas chamber is maintained at atmospheric pressure, the entire pressure differential being provided by the negative electrolyte pressure. Preferably the fuel cell is arranged so that in operation the gas is at a low positive pressure of no greater than +5.0 kPa.

The containing of gases at high pressures (for example, a pressure of approximately +10 kPa) poses technical problems that constrain the design of fuel cell assemblies. In particular, the containing of fuel gases such as hydrogen, which permeate relatively easily through barriers at high pressures, is not straightforward. The fuel cell assemblies of the present invention that are operated with a pressure differential between the electrolyte and the gases that is at least partly established by maintaining the electrolyte at a negative pressure may circumvent some of the problems associated with designing a fuel cell assembly. The containing of aqueous electrolytes at negative pressures has been found to be more easily achieved than containing gases at high pressures. Furthermore, it enables the pressure differentials between each of the gases and the ambient atmosphere and between the electrolyte and the ambient atmosphere to be modest, which simplifies construction.

In addition to the above mentioned advantages, the maintaining of an electrolyte at a negative pressure also reduces the risk that the electrolyte (such as KOH) leaks during operation, so the design of the electrolyte circuit of a fuel cell assembly may be simplified.

Furthermore, the reduced need to provide gases at high pressure in the fuel cell assemblies of the invention may allow them to be run more efficiently than prior-art assemblies in which a considerable amount of energy is required to run compressors and the like to maintain high gas pressures.

A further advantage of the fuel cells of the present invention is that the negative electrolyte pressure may assist the flooding of the fuel cell gas chambers with electrolyte on shutting down the fuel cell. On shut down the negative pressure of the electrolyte is no longer maintained, and as the electrolyte pressure rises to or above atmospheric pressure the interface between the electrolyte and the gas shifts so that the electrolyte flows through the permeable electrode and into the gas chambers. In a preferred embodiment a tank of electrolyte is provided in an elevated position with respect to the gas chambers of the cell and so electrolyte stored in the tank drains through the electrolyte chamber into the gas chambers filling each of the electrolyte and gas chambers with electrolyte. The fuel cell can then be stored in a flooded state which eliminates the need for the dormant fuel cell to be purged with inert gas (such as nitrogen) whilst inoperative. On starting up the fuel cell, the arrangement by which the negative electrolyte pressure is attained is also advantageously able to evacuate the electrolyte from the gas chambers into the electrolyte chamber of the fuel cell and into the optional storage tank. Thus, the need for a separate pacification system that supplies and maintains inert gas in the gas chambers on shut down is avoided.

A further advantage of fuel cell assemblies that operate with the electrolyte at a negative pressure is that the concentration of the electrolyte can be thereby controlled.

The fuel cell assembly of the invention may advantageously be arranged so that liquid produced by a chemical reaction occurring at the interface between the gas chamber and the electrolyte is drawn through the electrode into the electrolyte chamber. The maintenance of the electrolyte at a negative pressure during operation of the fuel cell assists in drawing liquid products of chemical reactions occurring at the electrodes (in particular, water) into the electrolyte chamber. Thus the need for management systems such as water management systems, dehumidifiers and the like to remove liquids from the gas chambers and to replace lost liquid to the electrolyte chambers is reduced.

The fuel cell assembly of the invention may advantageously be arranged so that the rate of production of water by the cell and the rate of water lost by evaporation are in equilibrium. The drawing back of water into the cells of the invention results in the rate of production of water by the cell being less than in prior art assemblies in which little water is drawn through the electrodes. Thus, in embodiments in which the catalyst layer of the electrode is exposed to the gas chamber less water is present on the catalyst surface of the electrodes.

The presence of water at the catalyst layer of an electrode reduces the efficiency of the catalyst b preventing the reactants (oxidant or fuel gas and electrolyte) coming into contact with the catalyst surface. Automatically drawing water back into the electrode enables the assembly to operate efficiently and productively by reducing the amount of water that is present on the catalyst surface. This is in contrast to previous fuel cell assemblies in which excess water runs down the surface of the catalyst before being removed from the gas chamber.

The amount of water lost to evaporation can be regulated by a number of variables. Those variables include the hydrophilicity of the electrode dividing the electrolyte and the gas (a highly hydrophilic electrode drawing water back into the electrolyte more readily). The pressure differential across the electrode of the electrolyte also affects the rate at which water is drawn into the electrolyte. When the electrolyte is KOH it has been found that reducing the KOH pressure (i.e. so it is less negative), causes the KOH concentration to rise (as less water is drawn in from the anode), which in turn causes the vapour pressure to fall and that slows down the rate of evaporation. As the vapour pressure is affected by concentration and temperature, and affects the evaporation rate, the electrolyte pressure can be used to control the KOH concentration balance and the evaporation rate. The higher the concentration of a KOH electrolyte, the more water is drawn into the electrolyte chamber: concentrations of KOH of 4.5 to 7 molar have been found to be satisfactory in drawing water into the electrolyte at 65° C. The flow rate of gases in gas circuits may also be adjusted so that the evaporation is balanced with the water production, air flow rates set so that around three times the required amount of oxygen passes through the cell than is required by the chemical reactions of the cell being typical. Provided that the air flow is proportional to the current drawn from the cell, stability will result.

It has been found to be relatively straightforward to adjust the electrolyte pressure so that the level of water produced and that is lost to evaporation in a fuel cell are in equilibrium. That is, the amount of water drawn into the cell and the amount being lost to evaporation are regulated to match the level generated in the electrochemical reaction.

Advantageously, the fuel cell assembly is arranged so that the rate of absorption of water from the gas chamber into the electrolyte chamber is such that the concentration of the electrolyte is substantially constant. It will be appreciated that the overall reaction of the fuel cell produces water. Water is produced at the anode, and is drawn into the electrolyte; the excess water produced by the cell is evaporated at the cathode into the air stream. Further evaporation may also occur at other places, for example an electrolyte reservoir. Arranging the assembly so that the rates of water consumption from and absorption into the electrolyte are balanced, eliminates the need for equipment to maintain a constant electrolyte concentration by replacing water consumed from the electrolyte or removing excess water.

Embodiments of the fuel cell assemblies of the invention have been found to be more suited for use in low temperature environments than conventional fuel cells, as there is no free water but only an electrolyte solution, so the assemblies are less susceptible to problems caused by freezing.

Preferably the fuel cell electrode comprises a porous and permeable substrate upon which conductive material and a catalyst are mounted. Advantageously, the porous substrate is hydrophilic. Hydrophilic substrates have been found to assist entry of the electrolyte (which in the case of alkaline fuel cells is an aqueous solution of, for example, potassium hydroxide) into the pores of the substrate.

The hydrophilic nature of the preferred substrate means that water spreads on the surface of the substrate. In contrast hydrophobic materials repel water, which forms beads on the surface, the water contact angle being greater than 90°. Preferably the substrate has a water contact angle of no greater than 90°, more preferably no greater than 60° and still more preferably no greater than 45°. The lower the water contact angle the greater the hydrophilicity of the substrate. In some preferred embodiments the substrate has a zero contact angle with water, such that the substrate is wetted by water.

The term “water contact angle” refers to the angle formed between the surface of a solid and the tangent to the water droplet surface from the point of contact of the water and the solid.

Another property linked to the hydrophilicity of the preferred substance is the surface energy (which may be referred to as surface tension). The substrate advantageously has a surface energy of greater than 40 mJ m⁻², preferably no less than 50 mJ m⁻², more preferably no less than 60 and still more preferably no less than 70 mJ m⁻². The hydrophilic substrate may attract water in a sponge-like manner being instantly wettable. A substrate without any chemical affinity for the electrolyte may result in the electrolyte failing to enter the pores due to surface energy effects, thus dramatically reducing the efficiency and/or performance of the electrode.

Preferably the substrate consists essentially of plastics materials, plastics materials being preferred as they typically have one or more advantageous properties such as being uniform in structure, flexible, easy to mass produce and capable of being made very thin whilst maintaining a suitable level of mechanical strength without becoming brittle. Preferably the plastics substrate of the invention is treated to increase the hydrophilicity of the substrate. The substrate may be a polymeric plastics material, such as a polyamide or polyolefin; preferably, it is a polyolefin. For example a substrate (which may for example be a polyethylene (PE) or polypropylene (PP) substrate) may be treated in order to increase the surface energy of the substrate to more than 40 mJ m⁻². Suitable treatment processes include grafting processes whereby chemical groups are attached to the polymer backbone without scission of the polymer chain. For example, a PP, PE or combined PP/PE polymer may be grafted in a process in which free radicals are created in the polymer surface by abstraction of hydrogen atoms using UV radiation in the presence of a photo-initiator and then monomer units combine with the radical. Such a process enables hydrophilic vinyl monomer units to be grafted onto a hydrophobic polymer chain. Grafting techniques may advantageously enable the entire surface of the polymer to be treated including the inside of pores so significantly increasing the ability of the material to draw up water (sometimes known as the wicking characteristics). Other treatment techniques such as coating the substrate may also be used but such techniques are less preferred than grafting processes as they have been found to be less efficient in increasing the wicking characteristics of the substrate.

The provision of a hydrophilic substrate has been found to assist in drawing water or aqueous solutions produced in fuel cell reactions into the electrolyte chamber; it also enables the interface between the gas and an aqueous electrolyte to be maintained at the catalyst of the electrode.

The invention further provides a method of operating a fuel cell assembly comprising an electrolyte chamber, a gas chamber and an electrode, the method comprising maintaining the electrolyte chamber at a negative pressure. Preferably the electrical output of the fuel cell is monitored, and the negative pressure of the electrolyte is adjusted to maximise the output. This may be on the basis of variations in the cell voltage, or alternatively on the basis of cell output power (from measurements of both cell voltage and current).

A preferred embodiment of the fuel cell assembly of the invention will now be described, by way of example only, and with reference to the accompanying drawings in which:

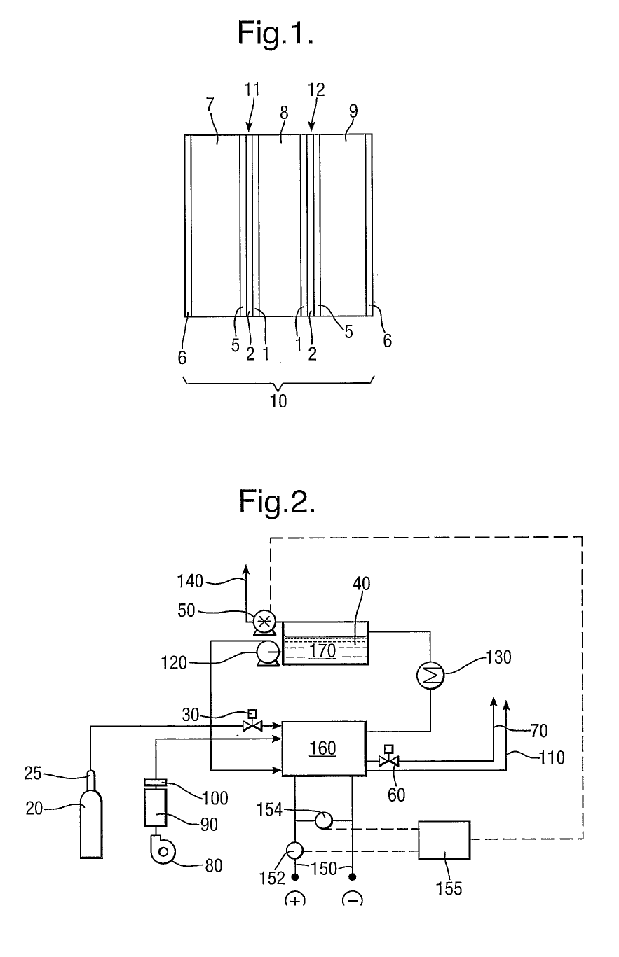

FIG. 1 shows a schematic diagram of a fuel cell suitable for use in a fuel cell assembly according to the invention;

FIG. 2 shows an embodiment of fuel cell assembly; and

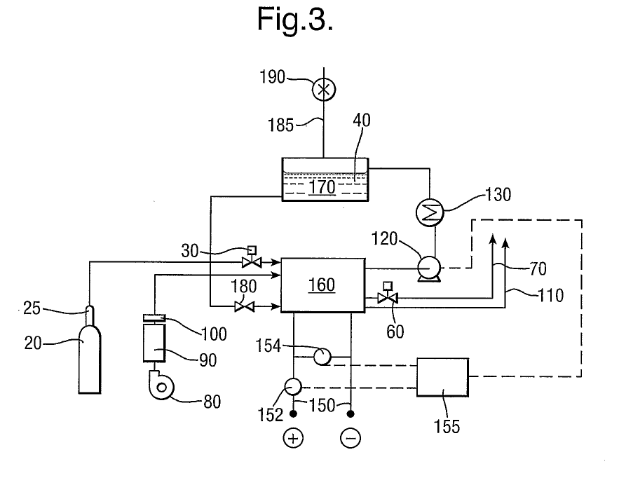

FIG. 3 shows a modification to the fuel cell assembly of FIG. 2.

The fuel cell of FIG. 1 is an alkaline fuel cell 10 comprising three chambers, a hydrogen gas chamber 7, a potassium hydroxide electrolyte chamber 8 and an air gas chamber 9. The electrolyte is a 6 molar solution of KOH in water. The fuel cell operates at an electrolyte temperature of 65° C., and air at three times the stoichiometric ratio (that is three times the required amount of air to oxidise the hydrogen) is passed through the air chamber 9 of the cell 10. Between the electrolyte chamber 8 and each of the two gas chambers 7, 9 is an electrode: an anode 11 (i.e. a negative electrode) is provided between the electrolyte chamber 8 and the hydrogen chamber 7, and a cathode 12 is provided between the electrolyte chamber 8 and the air chamber 9. In operation the pressure of gas in each of the gas chambers 7, 9 is about +2.0 kPa above atmospheric pressure, and the pressure of the aqueous KOH electrolyte in the electrolyte chamber 8 is about −10.0 kPa below atmospheric pressure.

The electrodes 11, 12 of FIG. 1 are built up of three main parts: a substrate 1 made of a sheet of hydrophilic porous treated polyethylene (such as that sold by SciMAT Ltd of Swindon, UK under the serial number 700/70); a conductive layer 2 comprising layers of conductive nickel and silver metal; and a catalyst layer 5 made up of palladium and platinum metal powders on activated carbon with a polyethylene binder. It will be appreciated that the catalyst compositions may be different for the anode and cathode, or alternatively they may have the same composition. Typically the total thickness of the substrate 1 is about 125 μm; the total thickness of the conductive layer 2 is about 5 μm, and the total thickness of the catalyst layer 5 is between 50 and 100 μm.

The side of each of the anode 11 and cathode 12 that is provided with the catalyst layer 5 is exposed to the gas chambers 7, 9, and the non-catalyst sides of the electrodes 11, 12 are exposed to the electrolyte chamber 8. The other sides of the gas chambers 7, 9 from the electrodes 11, 12 are provided with plates 6 that separate one cell unit from another. The plate 6 may be a further electrode (e.g an anode 11 may be adjacent to an anode 11 of an adjacent cell, separated only by a gas chamber 7, etc.); or the plate 6 may represent a bipolar plate (which separates a gas chamber 7 and an anode 11 on one side from a gas chamber 9 and a cathode 12 on the other side), a depending on how the fuel cell units are stacked together; or it may be a wall defining the end of the fuel cell stack.

The pressure differential of about 12.0 kPa between the gas chambers 7, 9 and the electrolyte chamber 8 is selected so the interface between the potassium hydroxide electrolyte and the hydrogen and air gases occurs at the catalyst layer 5, the interface being regulated by the pressure differential. At the anode 11 (the negative electrode) a chemical reaction occurs between the hydrogen gas and the hydroxide ions of the electrolyte, the products of which are water and electrons. At the cathode 12 a chemical reaction occurs between oxygen gas in the air chamber 9, water and electrons, the product of which is hydroxide ions. The electrons travel from the anode 11 to the cathode 12 via an electric circuit (not shown), so there is an electric current. The negative electrolyte pressure in the electrolyte chamber 8 and the hydrophilic substrate 1 create conditions in which water produced at the anode 11 is drawn into the electrolyte chamber 8, and the excess water produced in the reactions evaporates at the cathode 12 and is removed from the fuel cell in the air exhaust.

Referring now to FIG. 2, a fuel cell assembly is shown. A fuel cell stack 160 (consisting of a stack of cells 10 with the features described above) is supplied with hydrogen gas from cylinder 20, which is regulated by 2-stage regulator 25 and controlled by control valve 30. The hydrogen supplied to the hydrogen chambers 7 of the cells in the stack 160 is maintained at a low positive pressure of approximately +2.0 kPa (above atmospheric pressure) by means of the regulator 25 and the control valve 30. The air chambers 9 of the cell stack 160 are supplied with air by air blower 80 at a pressure of +1.8 kPa. Air blown by blower 80 is cleaned by passing through scrubber 90 and filter 100 before it reaches cell stack 160. The hydrogen does not normally flow out of the hydrogen chambers 7 (as it undergoes reaction there). There may be a buildup of contaminants within the hydrogen chambers 7, in which case a purge valve 60 is opened to allow a brief flow of hydrogen through the chambers 7, so that the hydrogen and contaminants are vented through a purge exhaust 70. Air and entrained evaporated water are exhausted through air exhaust 110.

A solution 40 of potassium hydroxide (KOH) in water, which is the cell electrolyte, is circulated by a pump 120 between the cell stack 160 and a tank 170 via heat exchanger 130, which removes excess heat. In the preferred mode of operation the concentration of the electrolyte is constantly approximately 6 M. A depression pump 50 maintains a negative pressure in the electrolyte circuit and is exhausted through depression exhaust 140. The pump 50 removes water vapour that has evaporated in the tank 170, and any gases.

In operation of the assembly, the depression pump 50 maintains the electrolyte at a pressure below atmospheric pressure, the pressure in the electrolyte chambers 8 of the cell stack 160 being at −10 kPa (below atmospheric pressure) taking into account the effects of the pump 120, and the heat exchanger 130. The cell stack 160 generates electricity, supplied to an external circuit (not shown) through terminals 150.

The current flowing in the circuit and the voltage between the terminals 150 are monitored by sensors 152 and 154 connected to a microprocessor 155 which provides control signals to the depression pump 50 (these electrical connections being represented by broken lines). Hence the pressure of the electrolyte 40 is adjusted to ensure the optimum position of the interface between the electrolyte 40 and the gases, ensuring that the interface is within the catalyst layer 5 of each electrode 11 and 12.

Referring now to FIG. 3 there is shown a modification to the assembly of FIG. 2 in which there is no depression pump 50. The electrolyte recirculation pump 120 is arranged at the outlet from the fuel cell stack 160, and there is a restriction 180 at the electrolyte inlet to the fuel cell stack 160. In operation the recirculation pump 120 in combination with the restriction 180 ensures that the electrolyte within the stack 160 is at a negative pressure, as in the assembly of FIG. 2, whereas the electrolyte 40 in the storage tank 170 is at or above atmospheric pressure. There is also a vent pipe 185 with a valve 190 at the top of the electrolyte tank 40, so that any gases (such as hydrogen and oxygen) that collect in the tank 40 can be vented at intervals. The pressure of the electrolyte in the stack 160 is controlled in accordance with the electrical measurements, by the microprocessor 155, in substantially the same way as described above.

What is claimed:

1. A fuel cell assembly comprising at least one fuel cell and a pump, the or each fuel cell including a first gas chamber, an electrolyte chamber, and a second gas chamber, and two electrodes separating the electrolyte chamber from the gas chambers, the pump being arranged to reduce the pressure of an electrolyte in the electrolyte chamber to a negative pressure.

2. The fuel cell assembly as claimed in claim 1, including gas pressure regulator means for maintaining the gases in the gas chambers at a positive pressure during operation of the fuel cell assembly.

3. The fuel cell assembly as claimed in claim 1, wherein the electrode comprises a hydrophilic porous substrate.

4. The fuel cell assembly as claimed in claim 3, wherein the electrode comprises a hydrophilic porous substrate consisting essentially of plastics materials.

5. The fuel cell assembly of claim 1, wherein the fuel cell is an alkaline fuel cell.

6. The fuel cell assembly of claim 1, comprising means to monitor the electrical output of the fuel cell assembly, and means to control operation of the pump in accordance with the electrical output.

7. A method of operating a fuel cell assembly comprising an electrolyte chamber, two gas chambers and electrodes on either side of the electrolyte chamber separating the electrolyte chamber from the gas chambers, and the method comprising maintaining the electrolyte chamber at a negative pressure.

8. The method of claim 7, wherein a pressure differential is established between each gas chamber and the electrolyte chamber.

9. The method as claimed in claim 7, wherein electrodes at which water is produced are such that water produced at an interface between the gas and the electrolyte is drawn through the electrode into the electrolyte chamber.

10. The method as claimed in claim 9 wherein the rate of production of water by the cell and the rate of water lost by evaporation are in equilibrium.

11. The method as claimed in claim 10, wherein concentration of the electrolyte is controlled by adjusting the electrolyte pressure.

12. The method as claimed in claim 7, wherein the electrolyte pressure is controlled in response to measurements of the electrical output of the fuel cell assembly.

13. A fuel cell assembly comprising at least one fuel cell and a pump, the or each fuel cell including a first gas chamber, an electrolyte chamber, and a second gas chamber, and two electrodes separating the electrolyte chamber from the gas chambers; the pump being arranged to reduce the pressure of an electrolyte in the electrolyte chamber below that of a gas in at least one of the gas chambers; and also comprising means to monitor the electrical output of the fuel cell assembly, and means to control operation of the pump in accordance with the electrical output.

14. A fuel cell assembly as claimed in claim 13 wherein in each fuel cell the gas flow rate through at least one gas chamber is adjusted to balance evaporation of water into that gas chamber to the production of water by the fuel cell.

15. A fuel cell assembly as claimed in claim 13 wherein each electrode comprises a hydrophilic porous substrate consisting essentially of plastics materials.
